(19) United States
(12) Patent Application Publication
(10) Pub. No.: US 2019/0060148 A1
(43) Pub. Date: Feb. 28, 2019

(54) PERSONAL MOBILITY APPARATUS

(71) Applicant: GREATER MOBILITY, INC., OCALA, FL (US)

(72) Inventor: JACQUELINE MILLER, OCALA, FL (US)

(73) Assignee: GREATER MOBILITY, INC., OCALA, FL (US)

(21) Appl. No.: 16/077,448

(22) PCT Filed: Feb. 12, 2017
(86) PCT No.: PCT/US17/17582

§ 371 Date: Aug. 10, 2018

Related U.S. Application Data
(60) Provisional application No. 62/294,830, filed on Feb. 12, 2016.

(51) Int. Cl. A61G 7/10; A61G 5/14

(52) U.S. Cl. CPC A61G 7/1038; A61G 2200/36; A61G 2200/34; A61G 5/14

(57) ABSTRACT

A personal mobility apparatus includes ergonomic handrails that are specially configured for standing and sitting operations. The apparatus also includes a base with compression casters to provide a stable platform during use, yet facilitate easy movement of the apparatus when not in use.

### CROSS-REFERENCE TO RELATED APPLICATIONS

This application is a U.S. national stage filing of International Application No. PCT/US2017/017582, filed on Feb. 12, 2017, which claims priority to U.S. Provisional Application No. 62/294,830, filed on Feb. 12, 2016.

### BACKGROUND

### Field of Invention

The invention relates generally to a personal mobility apparatus. More specifically, but not by way of limitation, embodiments of the invention provide an apparatus, and components thereof, configured to assist a user in standing, sitting, or making other transitions.

### Description of the Related Art

Many persons who are elderly, weak, in a post-surgical condition, or otherwise physically disabled experience difficulty with mobility. Without suitable assistance, such persons have restricted movement and/or risk injury.

Canes, walkers, wheelchairs, lifts, and other mobility aids are known. Such aids have many shortcomings, however. For instance, canes, walkers and wheelchairs generally do not provide adequate support for certain types of transitions, such as for standing and sitting. This lack of support can lead to falls, resulting in serious or fatal injury. In addition, lifts and other known devices that do facilitate such transitions typically require one or more attendants/operators to position the mobility aid and/or assist the disabled person in making the transition. Moreover, many mobility aids are bulky, and thus difficult to reposition and/or store when not in use. An improved mobility aid that is specially adapted for transitions, may allow for greater personal independence, and/or is more easily moved and stored, is therefore needed.

### SUMMARY OF THE INVENTION

The invention seeks to overcome one or more of the limitations described above. In embodiments of the invention, a personal mobility apparatus includes ergonomic handrails that are specially configured for standing and sitting operations, yet can also be used for support during various standing exercises. The apparatus includes a base with compression casters to provide a stable platform during use, yet facilitate easy movement of the apparatus when not in use. Preferably, the handrails can be decoupled from the base, or folded toward the base, for convenient storage.

### BRIEF DESCRIPTION OF THE DRAWINGS

Embodiments of the invention are described with reference to the following drawings, wherein:

FIG. 1 is a perspective view of a personal mobility apparatus, according to an embodiment of the invention;

FIG. 2 is a perspective view of a handrail assembly, according to an embodiment of the invention;

FIG. 3 is a perspective view of a base assembly, according to an embodiment of the invention;

FIG. 4 is a perspective view of a caster assembly, according to an embodiment of the invention; and

FIG. 5 is an exploded perspective view of a caster assembly, according to an embodiment of the invention.

### DETAILED DESCRIPTION

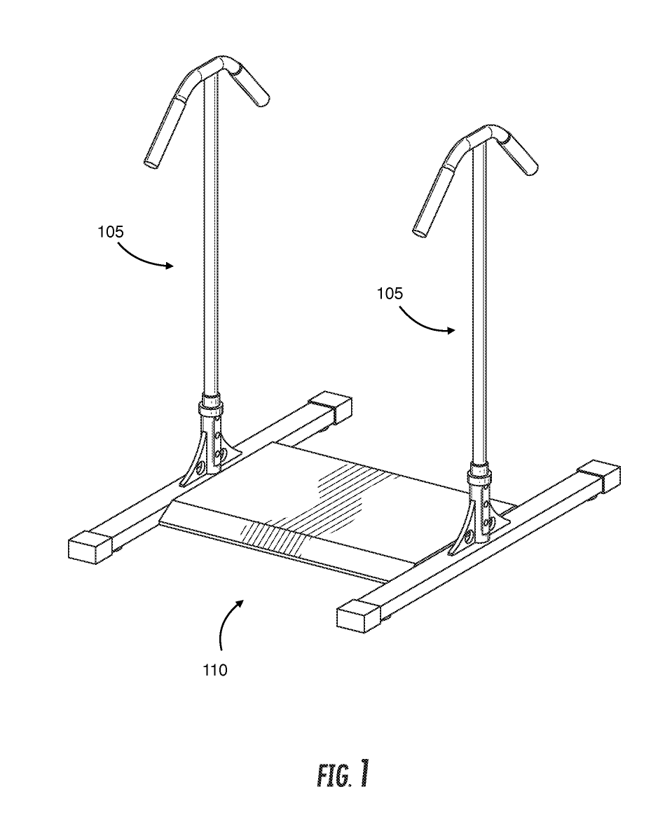

Embodiments of the invention are described below with reference to FIGS. 1-5. Such embodiments are meant to be illustrative and not restrictive. Reference designators are reused for the same or similar features. Features in the figures are not necessarily drawn to scale. Some features illustrated in the drawings may be exaggerated in scale. Other features may be simplified or omitted for descriptive clarity. Although section titles are used below for organizational convenience, the description of any feature is not necessarily limited to any section of this specification.

### Overview

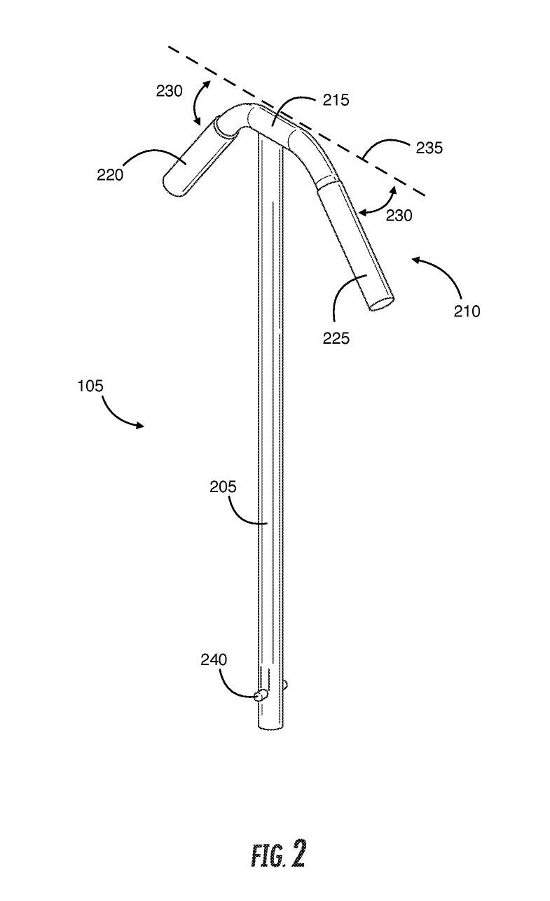

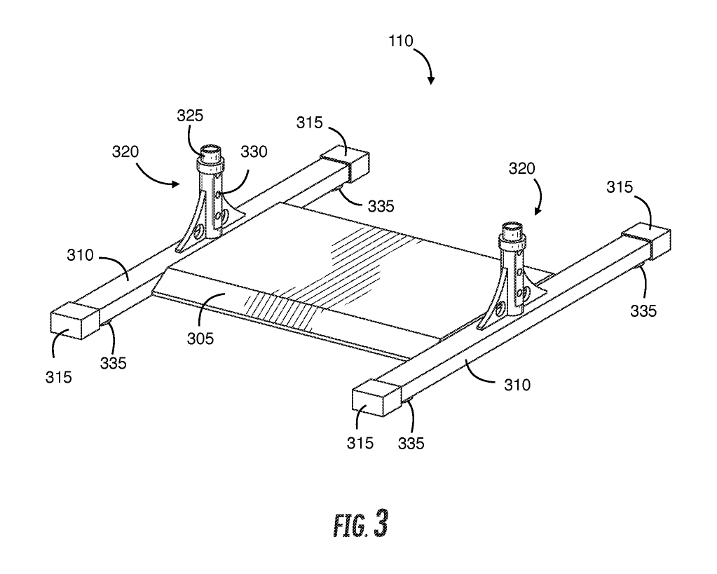

FIG. 1 is a perspective view of a personal mobility apparatus, according to an embodiment of the invention. In the illustrated embodiment, the apparatus includes two handrail assemblies 105 removably coupled to a base assembly 110. The handrail assemblies 105 will be further described with reference to FIG. 2 below; an embodiment of the base assembly 110 will be described with reference to FIGS. 3-5. The relative sizing of illustrated features could be varied according to design choice.

In one application, the personal mobility apparatus is disposed adjacent to the location where a user requires assistance standing. For instance, the apparatus may be positioned in front of a chair, bed, wheelchair, or commode. Then, from a seated position, the user places his or her feet on a portion of the base assembly 110, grips a portion of each handrail assembly 105, and stands. After standing, the user could return to the seated position (for example in a rehabilitation setting). Alternatively, the user could walk between the handrail assemblies 105 (for instance to a waiting walker).

The two handrail assemblies 105 can preferably be decoupled from the base assembly 110 to facilitate storage of the personal mobility apparatus. In an alternative embodiment (not illustrated in the Figs.), the handrail assemblies 105 could be hinged to the base assembly 110; in this instance, the handrail assemblies 105 could be disposed in a folded position adjacent to the base assembly 110 during storage.

### Handrail Assembly

FIG. 2 is a perspective view of the handrail assembly 105, according to an embodiment of the invention. As shown therein, the handrail assembly 105 includes a riser 205 rigidly connected to a handrail 210. The handrail 210 includes handrail tube 215, preferably with hand grips 220, 225 disposed on each end. The riser 205 and the handrail tube 215 could be fabricated, for instance, from 4130 chromoly tubing; the hand grips 220, 225 could be rubber, plastic, or a compound of rubber or plastic.

Preferably, the handrail tube 215 is bent at an angle 230 at each end with respect to horizontal 235 for improved ergonomics. For example, the angle 230 could be in the range of 11 to 45 degrees, and is preferably 22.5 degrees (+/−10%) so a user's wrists can be relatively straight under typical conditions when grasping the handrail 210 from a seated position.

The illustrated handrail assembly 105 also includes a button connector 240 disposed in the riser 205 to facilitate removable coupling to the base assembly 110.

Variations to the configuration of the handrail assembly 105 illustrated in FIG. 2 and described above are possible. For instance, the riser 205 and handrail tube 215 could be manufactured from steel, a steel alloy other than 4130 chromoly, or other material, according application needs. In another embodiment (not shown), the handrail tube 215 includes one or more articulated joints so the angle 230 can be adjusted between at least two different values. Moreover, in an alternative embodiment, the button connector 240 can be eliminated or replaced in favor of a different approach for removably fastening the handrail assembly 105 to the base assembly 110.

### Base Assembly

FIG. 3 is a perspective view of the base assembly 110, according to an embodiment of the invention. In the illustrated embodiment, the base assembly 110 includes a base plate 305 coupled between two sections of rectangular tube 310. The base plate 305 preferably includes a non-skid covering or texture (not shown) on a top surface. Foot pads 315 are disposed on each end of the rectangular tubes 310. Receiver assemblies 320 are fixed on a top surface of each rectangular tube 310; each receiver assembly 320 includes a receiver tube 325 that has multiple pairs of vertical adjustment holes 330. Two compression caster assemblies 335 are disposed on a bottom side of each rectangular tube 310, preferably near a corresponding foot pad 315 for maximum stability. The base plate 305, rectangular tubes 310, and receiver assemblies 320 are preferably made from 6061 aluminum. The foot pads 315 are preferably manufactured from rubber. Other materials could also be used, according to design choice, however.

In use, risers 205 are disposed in each of the receiving tubes 325. The button connector 240 cooperates with a selected pair of the vertical adjustment holes 330 to fix a height of the handrail 210. When downward force is not applied to the personal mobility apparatus, the caster assemblies 335 facilitate easy movement of the apparatus to other locations. On the other hand, when a user steps on the base plate 305, pulls downward on the handrail 210, or otherwise applies a downward force on the personal mobility apparatus, the caster assemblies 335 compress, the foot pads 315 engage a floor surface, and movement of the personal mobility apparatus is substantially restricted by frictional forces.

Variations to the base assembly 110 illustrated in FIG. 3 and described above are possible. For instance, in an alternative embodiment, each riser 205 includes a through hole instead of the button connector 240; in this instance, a clevis pin or other fastener (not shown) cooperates with the through hole and a selected pair of the vertical adjustment holes 330 to secure the handrail assembly 105 to the base assembly 110. In addition, in alternative embodiments, swivel casters having a wheel and compression spring could be mounted on outside faces of the rectangular tubes 310 instead of using (roller ball) caster assemblies 335 on a bottom side of the rectangular tubes 310 as described elsewhere in this specification.

### Caster Assembly

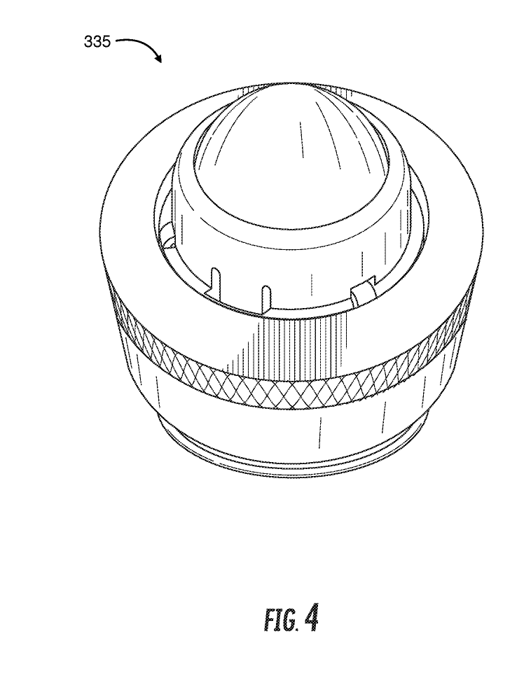

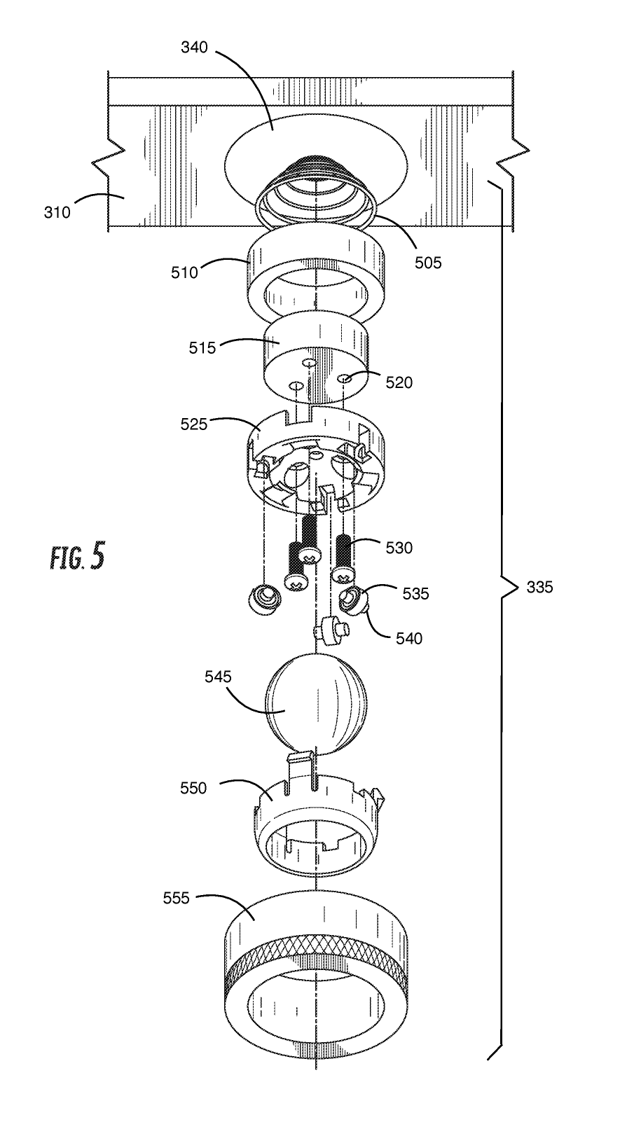

FIG. 4 is a perspective view of the caster assembly 335, according to an embodiment of the invention; FIG. 5 is an exploded perspective view of the caster assembly 335 disposed in a cavity 340 on a bottom side of the rectangular tube 310, according to an embodiment of the invention.

In the illustrated embodiment, the caster assembly 335 includes a compression spring 505, a sleeve 510, a spring cup 515 with threaded holes 520, a roller base 525, mounting screws 530, bushings 535 and corresponding pins 540, a roller ball 545, a roller cap 550, and an outer sleeve 555. The spring cup 515 and outer sleeve 555 are preferably made from aluminum, and the roller ball 545 is preferably steel, although other suitable materials could be used.

The spring cup 515 supports the compression spring 505. The mounting screws 530 secure the roller base 525 to the spring cup 520. The roller base 525 secures the bushings 535 and pins 540 to facilitate the rolling action of the roller ball 545. The roller cap 550 engages with the roller base 525 to support the roller ball 545 and also limit contamination of the caster assembly 335. The sleeve 510 is preferably made from teflon, and serves to reduce friction between the spring cup 515 and the outer sleeve 555 during compression/decompression of the caster assembly 335. The outer sleeve 555 protects components of the caster assembly 335 from collision with debris, flooring thresholds, or other obstacles to lateral movement of the personal mobility apparatus. Preferably, the outer sleeve 555 is press fit into the cavity 340. In embodiments of the invention, one or more roll pins (not shown) may be lately disposed to join one or more of the sleeve 510, spring cup 515, roller base 525, roller cap 550, and outer sleeve 555 for enhanced strength.

In operation, the compression springs 505 combine to resist slightly more than the weight of the personal mobility apparatus. As an example, the personal mobility apparatus may weigh approx. 30 lbs (not including the weight of the caster assemblies 335) and each of the four caster assemblies 335 may be able to resist 10 lbs of force over its operational vertical displacement; in this instance, a downward applied force that exceeds 10 lbs would overcome the compression springs 505 and restrict lateral movement of the personal mobility apparatus.

Variations to the configuration of the caster assembly 335 illustrated in FIGS. 4 and 5, and described above, are possible. For instance, in an alternative embodiment, the spring cup 520 and the roller base 525 could be combined into a single component. Likewise, the roller cap 550 and the outer sleeve 555 could be combined into a single component. Alternative materials could also be used.

### CONCLUSION

Embodiments of the invention thus better support standing and sitting transitions compared to known devices, facilitate the independence of users, and include features that enable compact storage. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Alternative features may be combined in ways not expressly illustrated or described. Many variations, modifications and alternative constructions therefore fall within the scope and spirit of the disclosed invention.

1. A personal mobility apparatus, comprising:
a base assembly having a base plate and a plurality of compression casters coupled to the base plate, each of the plurality of compression casters being configured to compress in height in response to a compression force;
the base assembly further having a plurality of foot pads coupled to the base plate, the base assembly configured such that, in use, each of the plurality of foot pads is suspended above a floor surface when the plurality of compression casters are not compressed, and each of the plurality of foot pads is in contact with the floor surface when the plurality of compression casters are compressed; and
a first handrail assembly and a second handrail assembly, the first and second handrail assemblies being coupled to the base assembly.

2. The personal mobility apparatus of claim 1, wherein each of the first and second handrail assemblies are removably coupled to the base assembly.

3. The personal mobility apparatus of claim 2, wherein each of the first and second handrail assemblies include a button connector, the base assembly including two receiving members, each of the two receiving members having a plurality of vertical adjustment holes configured to cooperate with the button connector.

4. The personal mobility apparatus of claim 1, wherein each of the first and second handrail assemblies are hingedly connected to the base assembly.

5. The personal mobility apparatus of claim 1, wherein each of the first and second handrail assemblies includes a tube with a hand grip portion, a longitudinal axis of the hand grip portion being disposed at an angle in the range of 11 to 45 degrees relative to horizontal.

6. The personal mobility apparatus of claim 5, wherein the angle is 22.5 degrees, with a tolerance of +/−10%.

7. The personal mobility apparatus of claim 5, wherein the hand grip portion can be articulated to fix the angle in each of a plurality of alternative settings.

8. The personal mobility apparatus of claim 1, wherein each of the plurality of compression casters is a swivel caster having a wheel disposed on an axle and a compression spring coupled to the axle.

9. The personal mobility apparatus of claim 1, wherein each of the plurality of compression casters includes:
a compression spring;
a spring cup configured to cooperate with the compression spring;
a roller base connected to the spring cup;
a roller cap connected to the roller base; and
a roller ball disposed between the roller base and the roller cap.

10. The personal mobility apparatus of claim 9, each the plurality of compression casters further including:
a teflon sleeve; and
an outer sleeve, the teflon sleeve being disposed between at least a portion of an outer surface of the spring cup and at least a portion of an inner surface of the outer sleeve.

11. A compression caster comprising:
a compression spring;
a spring cup configured to cooperate with the compression spring;
a roller base connected to the spring cup;
a roller cap connected to the roller base;
a roller ball disposed between the roller base and the roller cap;
a teflon sleeve; and
an outer sleeve, the teflon sleeve being disposed between at least a portion of an outer surface of the spring cup and at least a portion of an inner surface of the outer sleeve.
